(19) United States
(12) Patent Application Publication
(10) Pub. No.: US 2004/0165024 A1
(43) Pub. Date: Aug. 26, 2004

(54) Economical method & apparatus for objectively fixing error thresholds and checking color accuracy

(76) Inventors: Ferran Vilanova, Barcelona (ES); Santiago Bello, Santa Coloma de Gramenet (ES)

Correspondence Address: PETER I. LIPPMAN, 17900 MOCKINGBIRD LANE, RENO, CA, 89506, US

(21) Appl. No.: 10/371,957

(22) Filed: Feb. 21, 2003

(51) Int. Cl. B41J 29/393

(52) U.S. Cl. 347/19

(57) ABSTRACT

For a preferred incremental printing system (e. g. a remote-proofing printer system) and method, statistical methods of presetting calibration-acceptability criteria are used in the lab design phase, to objectively link acceptance of color calibration with printer performance—relative to design goals. A color calibration pattern is printed on the same sheet with substantially each image, and with a fiducial mark for later locating the calibration pattern, in a relatively narrow marginal region. The calibration pattern—a subset of a pattern used in full color-correction operation—is scanned by a measurement sensor, together with unprinted blank printing medium immediately adjacent to the calibration pattern, to first calibrate the sensor itself (A/D conversion gain and offset) and then check colorimetric calibration of the image-forming functions of the printer.

### RELATED PATENT DOCUMENTS

Related documents include other, coowned U.S. utility-patent documents hereby incorporated by reference in their entirety into this document. They are in the names of Francesc Subirada et al., Ser. Nos. 09/919,207 and 09/034,722, later issued as U.S. Pat. Nos. 6,___,___ and 6,___,___ respectively; Pau Soler et al., application Ser. No. 09/919,260, issued as U.S. Pat. No. 6,___,___; Thomas Baker et al., Ser. No. 09/183,819, issued as U.S. Pat. No. 6,___,___; Antoni Gil Miquel, Ser. No. 09/642,417, later issued as U.S. Pat. No. 6,___,___; Vilanova et al., Ser. No. 09/945,492, issued as U.S. Pat. No. 6,___,___; Jodra et al., Ser. No. 09/832,638, issued as U.S. Ser. No. 6,___,___; Jodra et al., attorney's docket code 60011837Z154, later assigned Ser. No. 10/___,___ and issued as 6,___,___; Boleda et al., Ser. No. 09/942,070, issued as 6,___,___; and others cited therein.

### FIELD OF THE INVENTION

This invention relates generally to machines and procedures for printing text or graphics on printing media such as paper, transparency stock, or other glossy media; and in some cases more particularly to a machine and method used in a remote-proofing system. The invention is preferably implemented in a scanning thermal-inkjet machine and method that construct text or images from individual ink spots formed in a pixel array.

### BACKGROUND OF THE INVENTION

As shown in the related patent documents mentioned above, the marketplace in incremental printers (sometimes known by the shorthand phrase“computer printers”) places a major premium on color consistency, i. e. on the provision of two or more printers that print alike. Consistent color is very desirable in both commercial use and most kinds of personal home use.

One type of printing—but by no means the only important type—that demands highly consistent color is remote proofing. Here, very frequently, two incremental printers in widely separated locations in the field are expected to produce images that not only look like each other but also look like a final image that will be printed on yet a third printer.

That third printer in most cases is of an entirely different kind, most typically a rotary offset printing press. Asking for an image to appear identical as printed on three different printers is a major challenge.

As explained in the above-mentioned patent documents, remote proofing is a valuable function in the printing industry. The value of a remote-proofing network, however, depends very strongly upon reliable, consistent color measurements performed by many different, widely separated remote-proofing printers in the field.

Accordingly it has been made possible to remotely check the color accuracy of certain networked remote-proofing printers, particularly those of the Hewlett Packard Company, before proceeding with proofing. These printers are part of a broader product line in which each unit is capable of a self-administered color-correction procedure, using a color test pattern.

The pattern is both printed and then measured by the printer itself. Preferably these steps are performed immediately before or after each image or group of related, similar-subject-matter images to be printed.

The present document further pursues the goal of color consistency for remote proofing—but also for incremental printing in general. Although certain portions of this document and of the appended claims focus upon remote proofing, the discussion and teachings of this document are applicable more broadly.

The Vilanova '492 document introduces the procedure of performing a color check by printing a color calibration pattern similar to the pattern used in the color correction. That document prescribes printing the test pattern on a common sheet of printing medium, directly adjacent to one or more actual images to be printed, and particularly between such an image and the edge of the sheet.

A scanning measurement of the printed calibration pattern is then automatically interpreted by the system. In response the apparatus then provides either an entire new color correction or simply a pass/fail criterion for deciding whether the a printer is appropriately color-calibrated.

(a) Objectives and constraints—In a profit-seeking production context, cost of the printing medium is a significant consideration. Preferably any test pattern should be printed using minimal amounts of printing medium beyond what is required for a desired image itself.

This constraint in turn leads to printing of the calibration pattern as close as possible to an edge of the sheet of printing medium. Printing and reading a test pattern in such-positions, however, can be troublesome.

With certain types of printing equipment the edge of the sheet has a tendency to curl upward or sometimes downward, varying the distance between the printing medium and the image-forming elements (inkjet nozzles, for example) or subsequently used sensing element. Such variation can change both the colorimetric character of what is being printed and the response of a sensor positioned above the test pattern to measure what has been printed.

The net result is that the calibration obtained near the edge of the sheet is not reasonably valid for the colors printed within the image, farther from the edge. Such operation of course defeats the purpose of performing a calibration.

As noted above, the calibration pattern is to be printed, scanned and interpreted quite frequently—typically several times a day, to accompany each image or group. Therefore it is strongly desirable that each performance of this procedure occupy as little time, and consume as little colorant, as possible or practical.

The calibration test pattern used for color correction, however, includes complete ramps for all primaries including black—and in some cases also for dilute primaries, and secondary colorants as well. The printing, scanning and interpretation of these full data sets can typically take five minutes, and this is an objectionably long time from the viewpoint of most proofing operators.

Furthermore printing the pattern consumes a quantity of printing medium and colorant. These end-user costs, too, are objectionable.

Developing an entirely new test pattern and procedure, on the other hand, could represent a significant engineering effort. Such a commitment of resources would be somewhat out of proportion to the desirability of a calibration check for each image or group.

(b) Calibration pass-or-fail criteria—Generally speaking, a conventional calibration check would fundamentally ask whether the printed color is in agreement with nominal. Although it may be conventionally recognized that perfect agreement is an impossibility, typically little attention is addressed to the question of how much departure from nominal should be accepted.

Perhaps most commonly an arbitrary margin for imperfection is allowed by an apparatus or software designer. It is not intended to unduly criticize such effort; however, what is at stake in determining the size of such an allowance is of considerable economic importance.

In particular, if the margin allowed is arbitrary and too low—objectively speaking—then excessive amounts of time, ink, paper, money and annoyance will be incurred in rechecking calibration that is already adequate. On the other hand if the margin allowed is arbitrary and too high, then either:

(1) excessive amounts of all the same resources will be incurred in reprinting images that were printed with unacceptable color; or

(2) consumers or other end-users will be dissatisfied with the color, ultimately leading to dissatisfaction with and rejection a printer product line, or a proofing system, or a commercial remote-proofing service—or all of these.

Accordingly it would be preferable to use some more-systematic or more-objective approach to determining the amount of margin for error.

(c) Conclusion—Thus persistent problems of economics, colorimetric variation with pen-to-print-medium spacing, and definition of what divergence from nominal color should be accepted, have all continued to impede achievement of uniformly excellent incremental printing. This is particularly true for—but not limited to—remote proofing. Thus important aspects of the technology used in the field of the invention remain amenable to useful refinement.

### SUMMARY OF THE DISCLOSURE

The present invention introduces such refinement. In its preferred embodiments, the present invention has several aspects or facets that can be used independently, although they are preferably employed together to optimize their benefits.

In preferred embodiments of a first of its facets or aspects, the invention is a printer-checking method. It includes automatically performing several steps, including printing a color calibration pattern.

Another is—with a particular sensor—measuring calibration-pattern colors. Yet another step is comparing the measurements with product-line data.

A further step is, for substantially each measurement, deriving a statistic pair that includes a product-line statistic and a particular-sensor statistic. Still other steps are, from each statistic pair, computing an overall statistic; and, based on the overall statistic, deciding whether color is acceptable.

The foregoing may constitute a description or definition of the first facet of the invention in its broadest or most general form. Even in this general form, however, it can be seen that this aspect of the invention significantly mitigates the difficulties left unresolved in the art.

In particular, by selecting color-acceptability criteria based upon statistics about the product line and the measurement sensor, the economics of proofing is placed on a sound objective footing.

Although this aspect of the invention in its broad form thus represents a significant advance in the art, it is preferably practiced in conjunction with certain other features or characteristics that further enhance enjoyment of overall benefits.

For example, it is preferred that the printing, measuring, computing and deciding steps are performed automatically by the printer in a field environment. If this preference is observed, then it is further preferred that at least the deriving step is performed in laboratory design work for a product line prior to manufacture of the printer.

If this further preference in turn is also observed, then it is still further preferred that the deriving step be coordinated with design goals for color accuracy in the whole product line. By virtue of such coordination, substantially all actually accepted color results can be brought within the product-line design goals for color accuracy. In other words the above-mentioned benefit of objectivity is, with care, readily extended to provide in each printed image actual colors that are correct, within design goals.

Yet another preference is that a result of the deciding step be transmitted by the printer, at a printing station, to another printer station for confirmation or evaluation. Another preference is that the method further include the step of then performing a color-correction procedure before relying on a printout made by the printer—but this step is performed only if the deciding-step result is negative.

Although this last-mentioned preference calls for a color-correction procedure in event of a negative result, nevertheless the printing step includes printing a reduced subset of colors from a different color calibration pattern used automatically by the same printer for the color-correction procedure. It is also preferred that the measuring step include reading unprinted bare printing medium, adjacent to the calibration pattern to compute the distance from printing elements to the printing medium at the pattern; the computed distance is then used to adjust color measurements.

In preferred embodiments of a second of its aspects, the invention is a remote-proofing method, again with automatically performed steps. One of these is printing a color calibration pattern with the printer.

Other steps are measuring calibration-pattern colors with a measuring device; and, based on the measurements, deciding whether color is acceptable. Yet another step, if a result of the deciding step is negative, is then performing a color-correction procedure.

The printing step comprises printing a reduced subset of colors from a different color-calibration pattern used automatically by the same printer for the color-correction procedure.

The foregoing may constitute a description or definition of the second facet of the invention in its broadest or most general form. Even in this general form, however, it can be seen that this aspect of the invention too significantly mitigates the difficulties left unresolved in the art.

In particular, this arrangement enables leveraging the engineering work that goes into the full color-correction protocol. As a result this functionality can be provided without a major engineering effort.

Although this second aspect of the invention in its broad form thus represents a significant advance in the art, it is preferably practiced in conjunction with certain other features or characteristics that further enhance enjoyment of overall benefits.

For example, it is preferred that a result of the deciding step be transmitted by the printer to another remote-proofing station for confirmation or evaluation. Another preference is that the method further include the step of then performing a color-correction procedure before relying on a proof made by the printer—but this step is performed only if the deciding-step result is negative.

It is also preferred that the measuring step include preliminary measurement of at least a black ramp in the test pattern—and self calibration of the measuring device based upon that preliminary measurement. Another preference is that the measuring step further include preliminary measurement of saturated patches of primary colors; and that the self calibration include adjustment of gain and offset for the measuring device, based on the black and saturated-color preliminary measurements.

Another preference is that the printing step include concatenating the color-calibration pattern with a production image to be printed, and printing both the pattern and image together as a single print job. If this is done, then a further nested preference, i. e. subpreference, is that the printing step include printing the calibration pattern in the margin of the production image.

If this latter subpreference too is observed, then it a further subsubpreference is that the printing step include printing a fiducial mark with the calibration pattern, and that the measuring step included locating the calibration pattern by the fiducial mark. Finally, if this is done it is still further preferable that the measuring step include scanning white space adjacent to the calibration pattern; this is done to enable compensation for variation in distance between image-forming elements and the printing medium.

In preferred embodiments of a third of its basic aspects or facets the invention is a printer with automatic color-checking. The device includes a scanning inkjet print engine forming an image hardcopy on a printing medium.

The device also includes an image-data input; and some means for rendering data from the input to actuate the engine and form the image hardcopy, with first print parameters. For purposes of generality and breadth in discussion of the invention, these means may be called simply the “rendering means”.

Also included in the device are some means for printing a color calibration pattern in a margin of the medium, with the image, but with second print parameters—which is to say, with print parameters that differ from those used in printing the image. The device further includes a sensor mounted in the engine for scanning to measure calibration-pattern colors.

Also included is an analog-to-digital converter operating on measurement signals from the sensor to derive digital measurement values. The device also includes some means for determining, based on the measurement values, whether color in the image hardcopy is acceptable; again for breadth and generality, these may be called the “determining means”.

The device further includes some means, responsive to preliminary measurement signals from the sensor, for setting offset and gain in the converter—once again, the “setting means”. Also included is a memory holding statistically derived calibration threshold values for comparison with the measurement values by the determining means.

The foregoing may represent a description or definition of the third aspect or facet of the invention in its broadest or most general form. Even as couched in these broad terms, however, it can be seen that this facet of the invention importantly advances the art.

In particular, by taking just a few seconds longer for adjusting the A/D converter gain and offset this third aspect of the invention ensures that it is truly reasonable to rely upon the sensor readings. In addition this aspect of the invention provides the same improved objectivity of statistically derived criteria that is enjoyed in practicing the first facet of the invention.

Although the third major aspect of the invention thus significantly advances the art, nevertheless to optimize enjoyment of its benefits preferably the invention is practiced in conjunction with certain additional features or characteristics. In particular, preferably the device further includes some means for scanning the sensor over the printing medium near the calibration pattern, to acquire data used in compensating variation in spacing between printing elements and the printing medium, near an edge of the medium.

Also preferably the threshold values are statistically derived in laboratory design prior to manufacture of the print engine. It is also preferable that the first print parameters include use of composite colors and application of a color profile; and the second print parameters include substantially pure primary colorants and substantial absence of any color profile.

All of the foregoing operational principles and advantages of the present invention will be more fully appreciated upon consideration of the following detailed description, with reference to the appended drawings, of which:

### BRIEF DESCRIPTION OF THE DRAWINGS

FIG. 1 is a simulation of a printing job to be proofed, showing an increased margin preferably below the production job for a color calibration pattern;

FIG. 2 is a like view showing that calibration pattern in position;

FIG. 3 is a flow chart representing processor operation according to certain preferred embodiments of the invention;

FIG. 4 is a probability distribution curve for colorimetric error in a representative proofing-printer product line;

FIG. 5 is a like curve for a subpopulation of well-calibrated printers within the line—i. e. printers that (speaking loosely) almost all, and almost always, produce colors well within colorimetric-accuracy design goals;

FIG. 6 is a like curve for a subpopulation of poorly calibrated printers—i. e. a printer group that contains a significant fraction that produce colors well outside those design goals, in a significant fraction of tests over time;

FIG. 7 is a probability distribution curve for individual readings of a nominally calibrated sensor, showing distribution of such readings about the correct actual value—which is taken as the mean;

FIG. 8 is a composite of FIGS. 4 and 7, showing the interrelationship of the two distributions;

FIG. 9 is a view like FIG. 8, but very greatly enlarged to show the overlap region for the tails of the two FIG. 8 probability functions;

FIG. 10 is a flow chart of product development incorporating preferred embodiments of the present invention; and

FIG. 11 is a block diagram, very highly schematic, of a hardware system according to some preferred embodiments of the invention.

### DETAILED DESCRIPTION OF THE PREFERRED EMBODIMENTS

### 1. Procedure

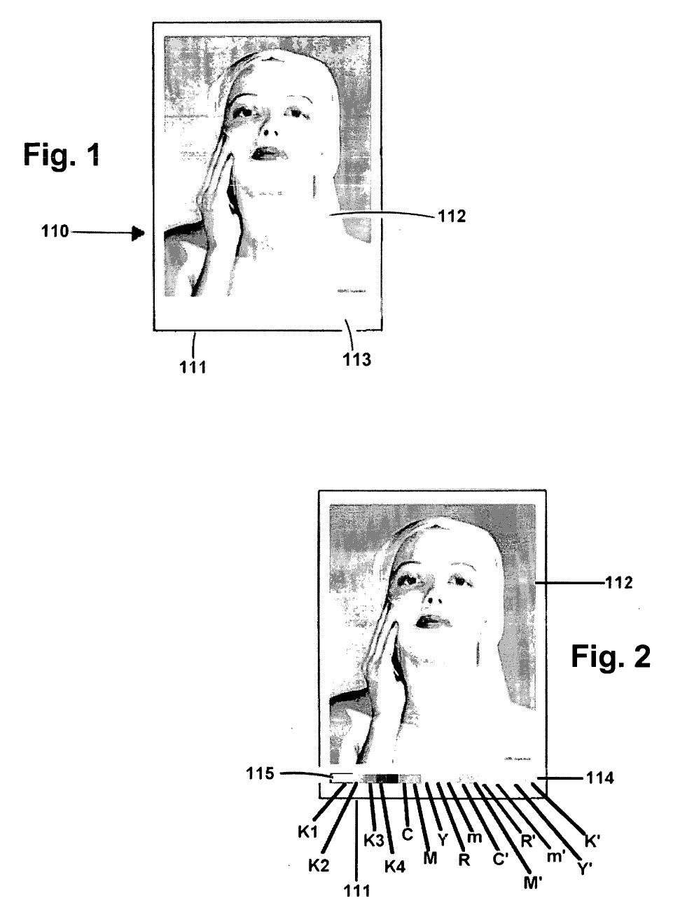

In preferred embodiments of the invention, a color check is performed—sometimes in a printer remote from the site of the intended final production—to validate color accuracy of a networked printer. This check is most preferably done concurrently with the hardcopy image 112 (FIG. 1) generation, rather than preliminarily.

The printer automatically leaves a wider margin 113 near the bottom of the sheet 110, between the image 112 to be shown and the bottom edge 111 of the sheet. In this wider margin the machine then prints a color calibration pattern or so-called “target” 114 (FIG. 2).

This calibration pattern is similar to (but only a subset of) one used in a full color-correction procedure. The printer will then scan the pattern with an onboard sensor to provide data for either just a pass/fail determination or (in event the test is failed) a full new color-correction procedure.

As suggested in the Baker patent document mentioned earlier, a true densitometer or even a calorimeter can be used for the measurements. In the interest of economy, however, for preferred embodiments of the present invention a carefully calibrated line sensor is used instead.

In a scanning inkjet printer the line sensor is carried on the printhead carriage for other purposes such as mutual alignment of the several heads. This device is accordingly available, without added cost, for the color calibration under discussion here.

In preparation for concurrent printing on a common sheet 110 of print medium with edges 111, the target 114 and the actual image 112 being printed are preferably concatenated in the controlling processor or associated memory. The production job is printed within paper limited margins to leave white space 113 (FIG. 1) for the target. These two elements, however, are not printed with common settings.

Rather the target is printed with mainly pure-primary ramps C, M, Y, c, m, C′, M′, Y′, c′, m′ (FIG. 2) and a black ramp K1-K4, K′—and preferably (to avoid complicating the color check) with no applied color profile. The chromatic part of the target may be simply one row of primary colorants CMYcm including the dilute colorants c, m; or may optionally also include a 50%-density row of the same five colorants C′M′Y′c′m′and 50% gray K′.

If preferred the target may also include a limited selection of secondary (red, blue and green) patches, not shown; and constructed-gray (i. e. process gray) patches to see neutrality (i. e. color balance), not shown. The image 112 of principal interest is instead printed with full use of composite colors, and with an applied color profile or profiles.

Such a profile, or profiles, or ideally a hybrid profile (as taught in the second above-mentioned Jodra patent document) relates the color behavior of the incremental printer—e. g. proof printer—to color behavior in some other device. The other device may be an intended final production printer, or another incremental printer where the same image may also be printed for comparison or discussion, or may be the viewing device used in original preparation of the color data.

A fiducial mark 115 is printed with the target 114. This mark facilitates later finding the correct starting position for the measurement scan.

Once printed, the color calibration pattern is scanned by the sensor to obtain a measure of color accuracy for at least each primary. Apparent lightness (and thereby indirectly saturation) depend upon the distance between the scanner and the printing medium 113—and in fact actual lightness and saturation also depend upon the distance between the printing elements (e. g. inkjet nozzles) and the printing medium.

Unfortunately as suggested earlier these distances vary strongly nearest the edges 111 of a sheet of print medium. Yet, to conserve the cost of printing medium that is used only for color calibration checking, it is desirable to print the target 114 as close as feasible to the bottom edge.

To avoid both target-printing errors and target-scanning errors, the distance from print medium to printing elements and to sensor are best monitored and controlled as taught by the earlier-mentioned Boleda document. To accomplish this the sensor is scanned over unprinted, bare print medium around or at least next to the printed target, and these parts of the sensor data are used to compensate for the distance variation.

Engineering work that has most typically already gone into a full color-correction procedure is leveraged—to avoid a sizable engineering effort simply to obtain a color accuracy check. Thus the full correction protocol is excerpted to provide the fiducial mark 114, and the sensor calibration of gain and offset settings.

The full correction also should provide built-in lookup tables for determining sensor-to-print-medium spacing from the optical measurements. These measurements are usually in the form of relative L*/b* data.

Thus, starting with the beginning 121 of the overall procedure for printing a remote proof or other hardcopy image, first the data for the main image 112 to be printed and the calibration-check pattern are concatenated 122, and the two printed together 123. At that point, when a conventional printer would eject the finished sheet of printing medium, the system here holds the sheet 124.

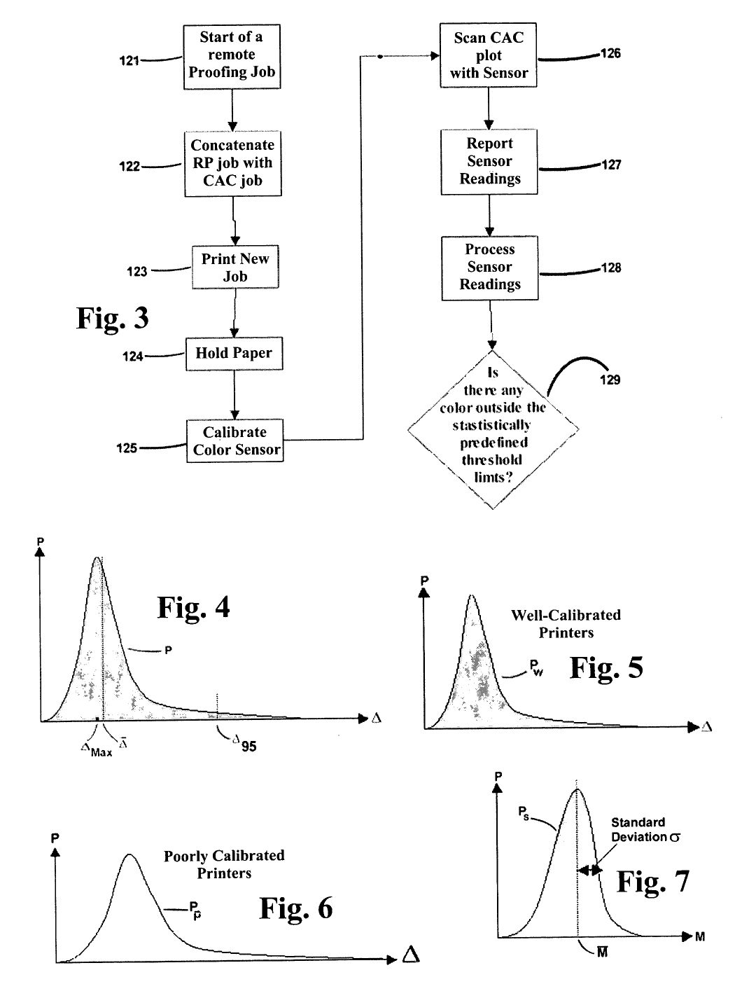

Next the sensor scans 125 (FIG. 3) the ramp of blacks and grays K1-K4, K′, and the full-saturation (100% density-content) patches CMY of the primaries, to gather information for sensor self calibration (A/D gains and offsets)—similarly to the way this is done for the full color correction. The necessary sensor-circuitry adjustments are then applied.

With sensor self calibration complete (i. e. with the A/D settings made), the sensor then scans 126 all the colors in the so-called “color accuracy check” (CAC) test pattern 114. Resulting data 127 are then compared 128, by an algorithm in the printer firmware, with predefined thresholds that are developed in the laboratory—a part of overall product-line design processes—as prescribed in the following subsection of this document.

The hardcopy print, which has already been made, is then either validated or disqualified 129. The outcome can be reported locally or remotely, or both.

### 2. Statistic-Based Laboratory Preparation

(a) Characterization of color error in a printer product line—For each colorant, a respective acceptability threshold T is statistically determined in the laboratory by means of a Monte Carlo analysis. This analysis takes into account two contributors to error, with a high degree of statistical confidence:

primary colorant brightness or saturation probability distributions; and

the well-characterized accuracy of the color sensor itself.

For all colorants but yellow, the CIE lightness L* is determined from the line-sensor readings and used as a measure of intensity of coloration.

Unfortunately L* in yellow is a poor measure of intensity; therefore instead an approximation to the CIE parameter b* is monitored for yellow. Some of the patent documents mentioned earlier provide further details on the determination of yellow through b* monitoring, which is nowadays rather commonplace.

Reproduction of color in a production printer/plotter such as the Hewlett Packard DesignJet 10ps is designed to be accurate. Even with a properly calibrated printer, however—or with any other physical device—there exists some level of inaccuracy.

For example consider a particular one-hundred-percent area fill of a particular colorant, e. g. cyan. For this 100% inking, the lightness L* of reflected light from the inked surface can vary from a nominal value N to an actual value A.

The error Δ=A−N in this actual reading can be of either sign, but its magnitude is of course the absolute value |Δ|=|A−N|, always positive. This may be the error in L* (or in b*, for yellow) for a particular printer in a product line.

For the whole population of printers, these errors are probabilistically distributed according to an empirical function P (FIG. 4). This distribution P is ordinarily asymmetrical, with a long tail that extends to values of A that are very high (but with extremely small likelihood), pulling the average value Δ to the right of the peak Δ_{MAX}.

Because the probability of very high error magnitudes is extremely low, all but five percent of the printers in the product line have error that is fairly close to the mean value Δ. Ninety-five percent of the machines exhibit error values equal to or less than a value Δ₉₅ that is very roughly twice the half-height width of the curve P above the mean \overline{Δ}.

Accordingly that point Δ₉₅ represents a so-called “ninety-five percent confidence” level. This probability analysis, in other words, makes us 95% confident that any given printer in the line—chosen at random—will display error equal to or less than that value Δ₉₅.

(b) Using color-error measurements in a “characterized” product line—Now, finding an actual measurement A with error Δ>Δ₉₅ means that |A−N|>Δ₉₅, or in particular A>N+Δ₉₅. Since the nominal measurement value N and the 95% confidence value Δ₉₅ are both known constants for the product line, their sum is too.

At the other end of the distribution curve P, the measured error Δ is very small—i. e., the color is perfect. The concern for such values is correspondingly little.

Nevertheless, within the product line characterized by \overline{Δ}, Δ_{MAX}, and Δ₉₅ there also exist subpopulations of well-calibrated and poorly calibrated printers. These two subpopulations, respectively, have in general somewhat smaller errors P_{W} (FIG. 5) and somewhat larger errors P_{P} (FIG. 6).

The left end of the curve P_{W} for the well-calibrated population substantially accounts for the left end of the curve for the overall population P, but is very slightly narrower and sharper. In a loose way of thinking about these functions, the point Δ₉₅ in the overall-population curve P is at roughly the same point in the well-calibrated-population curve P_{W}. The right end of the curve P_{P} for the poorly calibrated population substantially accounts for the right end of the curve for the overall population, but is broader and has a more-pronounced tail.

The question is whether a particular printer belongs to the population of well-calibrated printers (FIG. 5) or that of poorly calibrated printers (FIG. 6). This is the statistical form of asking whether a printer is calibrated well or poorly.

Statistically speaking, only the five percent of well-calibrated printers print a fully-inked patch with an error (relative to the nominal value N) of Δ₉₅ or more. In other words, upon encountering any error bigger than that we have a high confidence—actually we are 95% confident—that the printer is not well-calibrated.

Therefore, objectively a judgment about correctness of calibration can be based upon the measurement of that color, and comparison of the actually measured value A to the goal—i. e. to the nominal value N. Such a comparison, more specifically, compares A to N+Δ₉₅ as suggested above—and accepts the calibration if A≦N+Δ₉₅ but rejects it if A>N+Δ₉₅.

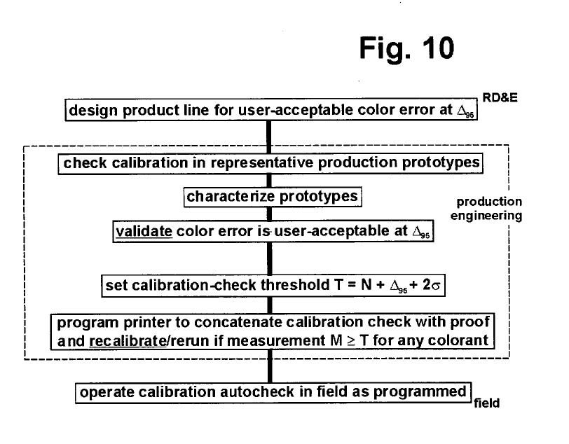

(c) Coordination of design with statistics—We accept, or can accept, printers with errors as great as Δ₉₅. This is permissible because the product line is engineered (FIG. 10) with variations sufficiently well controlled that the absolute color error at Δ₉₅ is still acceptable in terms of user perceptions, i. e. the perceptions of printing-industry customers.

Alternatively the acceptable confidence level can be made lower, e. g., Δ₆₀ (not shown). In the end, however, this could be more costly than production control—since it would reject proofs and other images, and require recalibrations, in forty percent of all cases rather than only five percent.

Ideally the overall product-line laboratory effort, production engineering as well as RD&E, is coordinated. The goal is that color-printing buyers will in fact consistently find color at Δ₉₅ acceptable—and not only in each of the primary colorants considered singly.

Color accuracy at Δ₉₅ should also be perceived as acceptable in each combination of colorants that goes into forming any possible (or likely) composite color the printer may be called upon to print. This is a challenging goal because human perception is very sensitive to subtle gradations of some composite colors, and in particular to departure from neutrality of constructed gray midtones.

(d) Accounting for experimental error also—The discussion in subsections (a) through (c) above might be the end of the teaching, if it were possible to measure a printed calibration-pattern color with perfect accuracy. The measurement itself, however, has uncertainty because a sensor with a given precision (i. e. imperfect reproducibility) performs it.

More specifically the sensor has an instrument error that can also be represented in the form of a statistical distribution of the sensor measurements M (FIG. 7)—now presumed to have a so-called “Gaussian” form P_{S}. In other words, the sensor error is assumed to be random, and to have a probability distribution P_{S} that is symmetrical about zero error. In fact the average error \overline{M} is zero.

This characterization of the sensor error as Gaussian also means that the error has a so-called “standard deviation” σ (sigma) equal to the half-height width of the sensor probability function P_{S}. As is well known, for such a distribution the actual measurements M will be farther from the average (\overline{M}=0 error) by more than ±3σ only at most once in about two hundred tries—which is to say, less than 0.5% of the time.

Nevertheless when the sensor measures a fully-inked colorant patch and reports a measurement M, this is commonly incorrect—i. e., somewhat inaccurate. The real, or actual, value A is around that but not exactly that.

In greatest likelihood (99.5% probability) the true value A is in the interval of A=M ±3σ. These thoughts lead to realization that there is an interplay between the color error distributions for the product line (FIG. 4) and the sensor (FIG. 7).

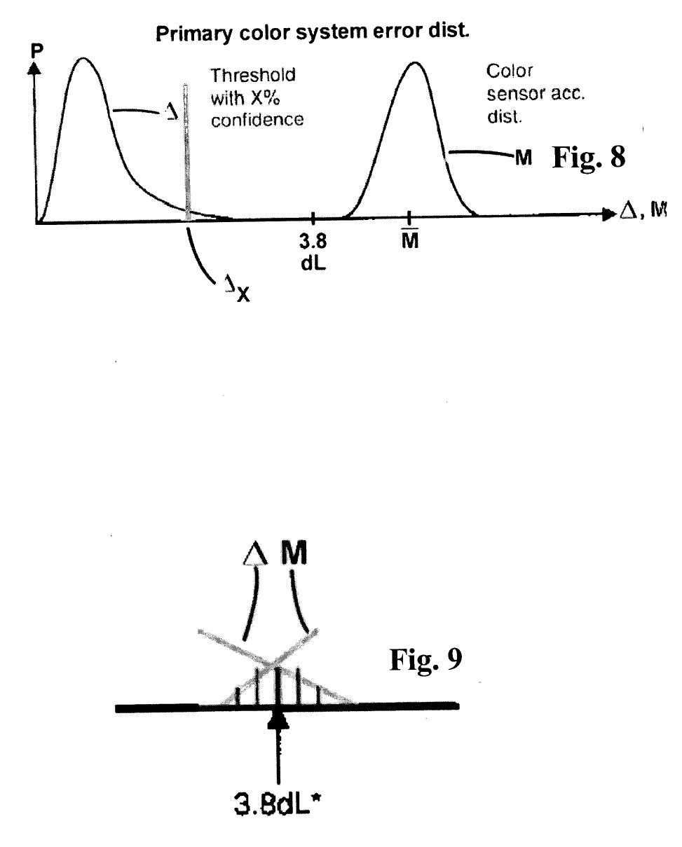

For any primary color these two error distributions Δ, M interact, and can be considered together (FIG. 8). As pointed out above, if the true measurement value A diverges from product-line nominal by Δ₉₅ or more, or in other words if A>N+Δ₉₅, then it can be affirmed with 95% confidence that the printer color is off.

When the sensor reports M>N+Δ₉₅, however, we know that the real value can be less than that, namely

A=M±3σ>N+Δ₉₅±3σ,

which can possibly be even as small as N+Δ₉₅−3σ (note the negative sign). Therefore the confidence that the actual measured value A represents a miscalibrated printer must decrease.

It is helpful at this point to make an educated guess as to the ideal tradeoff between uncertainties in (1) the product-line color characteristics and (2) the sensor calibration. Such a guess can be still illuminated by other objective statistical considerations. In particular, one advantageous and preferred decision is to set the good/bad threshold T=N+Δ₉₅+2σ.

The reasoning flowing from this choice will now be demonstrated. Assume that the printer is actually poorly calibrated; with 95% confidence, however, this can happen only if the actual value exceeds N+Δ₉₅.

In other words, we are assuming that the actual measurement A≧N+Δ₉₅. With the setting of T=N+Δ₉₅+2σ, however, if a measurement exceeds this threshold T it can be concluded first:

considering the statistics of the sensor error, there are few chances (fewer than 2.3%) that the real value is less than N+Δ₉₅; and

there are few chances (statistically fewer than 5%) that the printer is well-calibrated if the real value is N+Δ₉₅ or greater.

The 2.3% figure comes from the known properties of the Gaussian sensor-precision curve: the area under this curve reaches approximately 97.7% of the entire area, for limits of ±2σ—and the +2σ point has been set at Δ₉₅. Given an actual measurement of A≧T=N+Δ₉₅+2σ, then, the assumption that the real value actually exceeds Δ₉₅ therefore can be said to “fail” with a probability of only 2.3 percent.

The 5% figure, on the other hand, comes from the known property of the distribution curve P_{W} and in particular the definition of its Δ₉₅ point. By definition, a well-calibrated printer produces a color measurement greater than N+Δ₉₅ only five percent of the time: the assumption that the printer is poorly calibrated can be said to “fail” with a probability of only five percent.

Failure of both these components of the poor-calibration assumption would imply that the real measurement was actually less than N+Δ₉₅, despite the high measurement reading, or that the printer was actually well calibrated despite an actual value greater than N+Δ₉₅—or possibly both. In either case, the printer may have been actually well-calibrated, but this does require failure of both those limbs of the assumption; and:

the probability that in the end the two independent events fail at the same time is 2.3%×5%≅0.1%

Therefore it can be affirmed with nearly 99.9% confidence that a printer which outputs a measurement value M>T is poorly calibrated—i. e., that the machine in use should be recalibrated, rather than trusting the already-printed hardcopy printout.

In summary, if A≧T it is reasonable to recalibrate. If A<T it is reasonable to assume that the printout accurately represents the color data received—for the particular one colorant under consideration.

There are six separate thresholds for a printer with six colorants—and naturally correspondingly different numbers of thresholds for printers using different numbers of colorants. Only if all of the 100% colorant-density readings are within the limits (thresholds T) is the calibration validated, in preferred embodiments.

Considering again the interplay between product-line and sensor error distributions, and an example that differs only slightly: for a certain color the error Δ=dL* (or db*) may have form dL*=|L_{N}−L*|, where L_{N} is nominal brightness. (For yellow, db*=|b_{N}−b*|.) This color error has a probability distribution P (FIG. 8) that can be characterized.

Suppose that this distribution has an average value \overline{Δ}=1dL* and a 99% (ninety-ninth percentile) value of 3.5 dL*—that is, only one percent of errors exceed 3.5 dL*. This implies that if a full-density patch of the color were measured with a standard measurement device (spectrophotometer), then with 99% confidence it could be judged not calibrated if the difference in L* with respect to nominal L_{N} exceeded 3.5 dL*, i. e. if Δ>3.5 dL*.

In fact instead of a spectrophotometer the measurement is made with a color sensor that inherently has its own error with respect the spectro, i. e. with respect to a very reliable measurement. Therefore it is necessary to leave some margin—i. e. make an extra allowance in error—for the fact that the sensor contributes error, by combining the two error distributions.

Again, those are the color-sensor measurement-error distribution M, and the color error distribution Δ (or P, FIGS. 4 through 8) for a calibrated printer. This may in effect rescue the printer and its operator from a conclusion that time-consuming recalibration is needed.

Suppose that in this example the sensor produces a measurement of 3.8 dL* (FIG. 8)—nominally unacceptable. Given the sensor error distribution, however, there is a certain probability that the real measure is 3.5 instead, and the already-printed hardcopy printout is acceptable.

If the sensor error is distributed normally with a standard deviation σ=0.15, then the probability of having an actual value Δ=3.5 dL* when the sensor measures M=3.8 is 0.2. These probability curves intersect somewhere in the region between Δ_{X} and \overline{M} (FIG. 8), where both curves Δ and M have very low values.

The nature of the interaction may be understood from a very greatly enlarged view (FIG. 9) of that intersection, with the vertical scale highly exaggerated. Using a realistic assumption that the probability distributions for both events are independent, the probability of rejecting measurements for a printer that is well-calibrated is the product of the probabilities—the two distribution-function tails:

probability of color error 3.5 dL* in a well-calibrated printer=0.01;

probability of an actual color error of 3.5 dL* (if the sensor reports 3.8 dL*)=0.2; and

probability of accurate color (when the sensor is giving 3.8 dL*) therefore=0.01×0.2=0.002,

and it can be concluded that the color is wrong, with a confidence of 1−0.002=0.998, or 99.8 percent.

Wholly outside this analysis is the possibility of human error in selecting or manipulating image-device profiles or the like, with respect to e. g. a proof printer, or a production printer, or a source monitor. All such systematic error must be properly managed by the various techniques discussed in the other patent documents mentioned earlier.

In preferred embodiments of the invention, thresholds are not provided for the 50% colorant-density patches. These are used only to support the readings on the 100% patches—i. e., for a check of linearity (given the two related readings together with an implied zero level), or to reduce effective measurement noise by a weighted-averaging process.

### 3. Hardware for Implementing the Invention

As the invention is amenable to implementation in, or as, any one of a very great number of different printer models of many different manufacturers, little purpose would be served by illustrating a representative such printer. If of interest, however, such a printer and some of its prominent operating subsystems can be seen illustrated in several other patent documents of the assignee, Hewlett Packard—such as for example the previously mentioned document of Thomas Baker or that of Antoni Gil Miquel, which both particularly illustrate a large-format printer-plotter model.

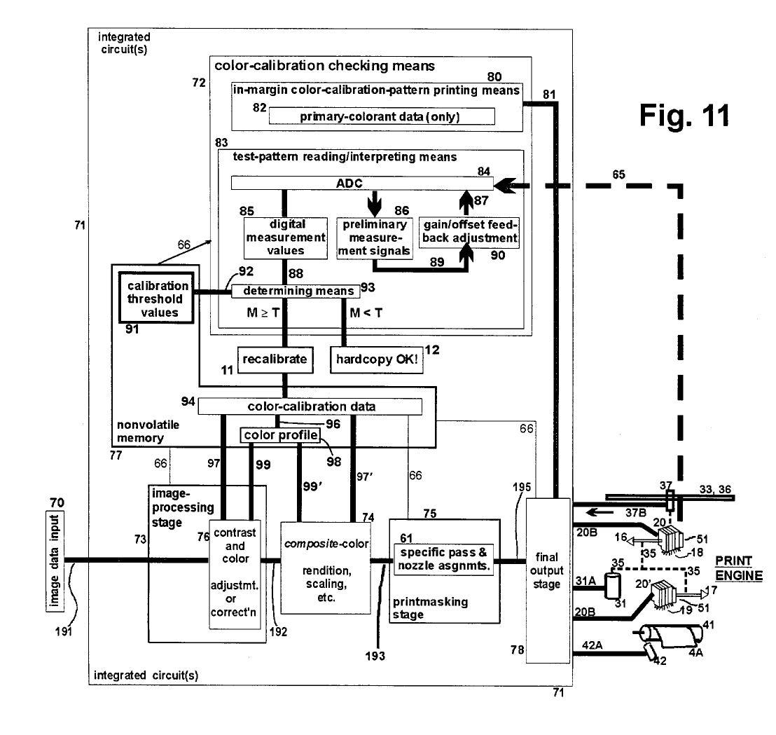

(a) The print engine—In some such representative printers, a cylindrical platen 41 (FIG. 11)—driven by a motor 42, worm and worm gear (not shown) under control of signals 42A from a digital electronic processor 71—rotates to drive sheets or lengths of printing medium 4A in a medium-advance direction. Print medium 4A is thereby drawn out of a supply of the medium and past the marking components that will now be described.

A pen-holding carriage assembly 20, 20′ carries several pens, as illustrated, back and forth 16, 17 across the printing medium, along a scanning track—perpendicular to the medium-advance direction—while the pens eject ink 18, 19. For simplicity's sake, only four pens are illustrated; however, as is well known a printer may have six pens or more, to hold different colors—or different dilutions of the same colors as in the more-familiar four pens. The medium 4A thus receives inkdrops for formation of a desired image.

A very finely graduated encoder strip 33, 36 is extended taut along the scanning path of the carriage assembly 20, 20′ and read by a very small automatic optoelectronic sensor 37 to provide position and speed information 37B for one or more microprocessors 71 that control the operations of the printer. One advantageous location for the encoder strip is immediately behind the pens.

A currently preferred position for the encoder strip 33, 36, however, is near the rear of the pen carriage—remote from the space into which a user's hands are inserted for servicing of the pen or refill cartridges. For either position, the sensor 37 is disposed with its optical beam passing through orifices or transparent portions of a scale formed in the strip.

The pen-carriage assembly 20, 20′ is driven in reciprocation by a motor 31—along dual support and guide rails (not shown)—through the intermediary of a drive belt 35. The motor 31 is under the control of signals 31A from the processor or processors 71.

Preferably the system includes at least four pens holding ink of, respectively, at least four different colors. Most typically the inks include yellow Y, then cyan C, magenta M and black K—in that order from left to right as seen by the operator. As a practical matter, chromatic-color and black pens may be in a single printer, either in a common carriage or plural carriages.

Also included in the pen-carriage assembly 20, 20′ is a tray (not shown) carrying various electronics. The output-printing stage discussed above includes carriage guide and support bars (not shown), as well as an end bracket.

(b) Orientation to block-diagram electronics—Before further discussion of details in the block diagram (FIG. 11), a general orientation to the electronics portions of that drawing may be helpful. This diagram particularly represents preferred embodiments of a previously discussed apparatus aspect of the invention.

Conventional portions of the apparatus appear as the printing stage 20, 20′ through 51, and 4A, discussed above, and also the final output-electronics stage 78 which drives that printing stage. This final-output stage 78 in turn is driven by a printmasking stage 75, which allocates printing of ink marks 18, 19 as among plural passes of the carriage 20, 20′ and pens across the medium 4A.

Also generally conventional are a nonvolatile memory 77, which holds operating instructions 66 and data 91, 94, 98 (certain of which are novel and implement the present invention) for all the programmed elements; an image-processing stage 73, rendition-and-scaling module 74; and color input data 70 seen at far left in the diagram. The data flow as input signals 191 into the processor 71.

Features particularly related to the apparatus aspect of the invention appear in the upper and upper-central region of the diagram as element 72, and elements 80 through 99, 99′; these will be detailed below. Given the statements of function and the diagrams presented in this document, a programmer of ordinary skill—if experienced in this field—can prepare suitable programs for operating all the circuits.

The novel features appear primarily in the color-calibration checking means 72—which include the test-pattern-generating circuitry 80, 82 and data path 81, as well as a data path 65 for information that results from reading of the test patterns by another small optical sensor 51 that also rides on the carriage.

The pen-carriage assembly is represented separately at 20 when traveling to the left 16 while discharging ink 18, and at 20′ when traveling to the right 17 while discharging ink 19. Both 20 and 20′ represent the same pen carriage, with the same pens.

The previously mentioned digital processor 71 provides control signals 20B to fire the pens with correct timing, coordinated with platen drive control signals 42A to the platen motor 42, and carriage drive control signals 31A to the carriage drive motor 31. The processor 71 develops these carriage drive signals 31A based partly upon information about the carriage speed and position derived from the encoder signals 37B provided by the encoder 37. (In the block diagram all illustrated signals are flowing from left to right except the information 37B, 65 fed back from the sensors 37, 51—as indicated by associated leftward arrows—and analogously the previously mentioned information 66 where shown passing to the calibration checking means 72, in a nonstandard direction.) The codestrip 33, 36 thus enables formation of color inkdrops at ultrahigh precision during scanning of the carriage assembly 20 in each direction—i. e., either left to right (forward 20′) or right to left (back 20).

The invention is not limited to operation in four-colorant systems. To the contrary, for example six-colorant “CMYKcm” systems including dilute cyan “c” and magenta “m” colorant (FIG. 2) are included in preferred embodiments as noted earlier.

The integrated circuits 71 may be distributive—being partly in the printer, partly in an associated computer, and partly in a separately packaged raster image processor. Alternatively the circuits may be primarily or wholly in just one or two of such devices.

These circuits also may comprise a general-purpose processor (e. g. the central processor of a general-purpose computer) operating software such as may be held for instance in a computer hard drive, or operating firmware (e. g. held in a ROM 77 and for distribution 66 to other components), or both; and may comprise application-specific integrated circuitry. Combinations of these may be used instead.

(c) Calibration checking, and printing—It is the small optical sensor 51, riding on the carriage 20, 20′, whose characterization has been discussed and illustrated (FIG. 7) in subsection 2 above. Still within the processor 71 and its calibrating unit 72, data 65 from the sensor pass to a previously mentioned ADC 84.

At different operating times the ADC produces two respectively different sets of data:

preliminary digital signals 86 proceed as feedback 89 to an electronic servocircuit 90 that generates ADC gain and offset adjustments 87, returned to the converter 84 (these signals, as mentioned earlier, are generated in response to only the gray ramp and 100% chromatic-colorant patches); and

final digital measurement information 85 proceeds 88 to the “determining means” portion of the circuit, which performs the simple test 93 discussed in section 2 above.

In the latter, final-measurement case, more specifically the determining means 93 compare the arriving digital measurement “M” values 85 with the calibration threshold “T” values 91 held in the system nonvolatile memory 77.

If the measurement M is less than the threshold T, the determining means issue a verification 12 that the already-printed hardcopy image 112 (FIGS. 1 and 2) is accurate within system specifications. Otherwise, the determining means instead issue a command 11 to recalibrate the color—i. e., to develop new color-calibration data 94 for storage in the nonvolatile memory 77.

Either the new or the preexisting calibration data 94, together with color-profile data 98, are passed 97, 97′, 99, 99′ to the color-correction module 76 and composite-color rendition module 74. There they are used in preparing input image data 70, 191 for printmasking 75; and for conversion 78 to machine language to energize the print engine.

Generation of printing parameters for printing a production proof or other image 112 thus includes:

passage 99, 99′ of printer-profile data 98 to the color-implementation circuits 76, 74; as well as

use of composite-color rendition 74. Generation of printing parameters for printing the calibration pattern 114, to the contrary:

passes no printer profile on toward the print engine; and

uses primary-colorant data exclusively—i. e., no composite colors.

In other words the generation of printing parameters in these two cases are quite different, as first stated in the earlier “SUMMARY OF THE DISCLOSURE” section of this document.

The above disclosure is intended as merely exemplary, and not to limit the scope of the invention—which is to be determined by reference to the appended claims.

What is claimed is:

1. A printer-checking method comprising automatically:
printing a color calibration pattern;
with a particular sensor, measuring calibration-pattern colors;
comparing the measurements with product-line data;
for substantially each measurement, deriving a statistic pair comprising a product-line statistic and a particular-sensor statistic;
from each statistic pair, computing an overall statistic; and
based on the overall statistic, deciding whether color is acceptable.

2. The method of claim 1, wherein:
the printing, measuring, computing and deciding steps are performed automatically by the printer in a field environment.

3. The method of claim 2, wherein:
at least the deriving step is performed in laboratory design work for a product line prior to manufacture of the printer.

4. The method of claim 3, wherein:
the deriving step is coordinated with establishment of design goals for the product line in such a way that substantially all actually accepted color results are within the product-line color-accuracy design goals.

5. The method of claim 4, wherein:
a result of the deciding step is transmitted by the printer, at a first printer station, to another printer station for confirmation or evaluation.

6. The method of claim 2, further comprising the step of:
if a result of the deciding step is negative, then performing a color-correction procedure before relying on a printout made by the printer.

7. The method of claim 4, wherein:
the printing step comprises printing a reduced subset of colors from a different color calibration pattern used automatically by the same printer for the color-correction procedure.

8. The method of claim 5, wherein the measuring step further comprises:
reading unprinted bare printing medium adjacent to the calibration pattern to compute the distance from printing elements to the printing medium at the pattern; and
using the computed distance to adjust color measurements.

9. The method of claim 1, wherein the measuring step further comprises:
reading unprinted bare printing medium adjacent to the calibration pattern to compute the distance from printing elements to the printing medium at the target; and
using the computed distance to adjust color measurements.

10. A remote-proofing method for use in a proofing station and comprising automatically:
printing a color calibration pattern with the printer;
measuring calibration-pattern colors with a measuring device;
based on the measurements, deciding whether color is acceptable;
if a result of the deciding step is negative, then performing a color-correction procedure; and wherein
the printing step comprises printing a reduced subset of colors from a different color calibration pattern used automatically by the same printer for the color-correction procedure.

11. The method of claim 10, wherein:
a result of the deciding step is transmitted by the printer to another remote-proofing station for confirmation or evaluation.

12. The method of claim 11, further comprising the step of:
if a result of the deciding step is negative, then performing a color-correction procedure before relying on a proof made by the printer.

13. The method of claim 10, wherein the measuring step comprises:
preliminary measurement of at least a black ramp in the test pattern; and
self calibration of the measuring device based upon the preliminary measurement.

14. The method of claim 13, wherein:
the measuring step further comprises preliminary measurement of saturated patches of primary colors; and
the self calibration comprises adjustment of gain and offset for the measuring device, based upon the black and saturated-color preliminary measurements.

15. The method of claim 10, wherein:
the printing step comprises concatenating the color-calibration pattern with a production image to be printed, and printing both the pattern and image together as a single print job.

16. The method of claim 15, wherein:
the printing step comprises printing the calibration pattern in the margin of the production image.

17. The method of claim 16, wherein:
the printing step further comprises printing a fiducial mark with the calibration pattern, and
the measuring step comprises locating the calibration pattern by the fiducial mark.

18. The method of claim 17, wherein:
the measuring step comprises scanning white space adjacent to the calibration pattern to enable compensation for variation in distance between image-forming elements and the printing medium.

19. A printer with automatic color checking; said printer comprising:
a scanning inkjet print engine forming an image hardcopy on a printing medium;
an image-data input;
means for rendering data from the input to actuate the engine and form the image hardcopy, with first print parameters;
means for printing a color calibration pattern in a margin of the medium, with the image, but with second print parameters;
a sensor mounted in the engine for scanning to measure calibration-pattern colors;
an analog-to-digital converter operating on measurement signals from the sensor to derive digital measurement values;
means for determining, based on the measurement values, whether color in the image hardcopy is acceptable; and
means, responsive to preliminary measurement signals from the sensor, for setting offset and gain in the converter; and
a memory holding statistically derived calibration threshold values for comparison with the measurement values by the determining means.

20. The device of claim 17, further comprising:
means for scanning the sensor over the printing medium near the calibration pattern, to acquire data used in compensating for variation of spacing between printing elements and printing medium, near an edge of the medium.

21. The device of claim 17, wherein:
the threshold values are statistically derived in laboratory design prior to manufacture of the print engine.

22. The device of claim 17, wherein:
the first print parameters comprise use of composite colors and application of a color profile; and
the second print parameters comprise substantially pure primary colorants and substantial absence of any color profile.
